(19) United States
(12) Patent Application Publication
(10) Pub. No.: US 2003/0050817 A1
(43) Pub. Date: Mar. 13, 2003

(54) Capacity- driven production planning

(76) Inventors: Brian D. Cargille, Palo Alto, CA (US); Gianpaolo Callioni, Palo Alto, CA (US); M. Eric Johnson, Hanover, NH (US)

Correspondence Address: HEWLETT-PACKARD COMPANY, Intellectual Property Administration, P.O. Box 272400, Fort Collins, CO, 80527-2400, US

(21) Appl. No.: 09/953,669

(22) Filed: Sep. 12, 2001

(51) Int. Cl. G06F 17/60

(52) U.S. Cl. 705/8

(57) ABSTRACT

Production planning systems and methods are described that enable production planners to see how capacity decisions affect total production costs and to understand the cost trade offs between excess capacity and inventory and, thereby, enable them to make appropriate manufacturing capacity level and inventory level decisions. In one aspect, a production planner may utilize the production planning systems and methods to plan inventory and capacity levels for one or more products produced on a manufacturing line. In addition to setting capacity and inventory levels, the production planner may use the production planning systems and methods to understand the impact of certain changes (e.g., reducing set-up time or down time, or moving products from one manufacturing line to another) on total production costs.

### CROSS-REFERENCE TO RELATED APPLICATIONS

This application is related to U.S. application Ser. No. ______, filed on even date herewith, by Brian D. Cargille et al., and entitled “Graphical User Interface for Capacity-Driven Production Planning Tool,” and to U.S. application Ser. No. ______, filed on even date herewith, by Brian D. Cargille et al., and entitled “Capacity-Driven Production Planning Tools,” both of which are incorporated herein by reference.

### REFERENCE TO COMPUTER PROGRAM LISTING APPENDIX

This application includes a computer program listing appendix consisting of a Microsoft® Visual Basics for Applications (VBA) computer program that is operable as a spreadsheet tool in the Microsoft® Excel® application program for implementing a capacity-driven production planning tool. The computer program listing appendix is contained on a single compact disk (“Copy 1”; submitted herewith) as filename 10017535-1 (1).txt, which was created on Sep. 10, 2001, and has a size of 53,653 bytes. This file is compatible with the IBM-PC machine format and the Microsoft Windows operating system. An identical, duplicate copy of the computer program listing appendix is contained on a second compact disk (“Copy 2”; submitted herewith) as filename 10017535-1 (2).txt, which was created on Sep. 10, 2001, and has a size of 53,653 bytes. The entire contents of the attached compact disks are incorporated herein by reference.

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### TECHNICAL FIELD

This invention relates, in general, to systems and methods for capacity-driven production planning and, in particular, to systems and methods of planning inventory and capacity levels for one or more products produced on a manufacturing line.

### BACKGROUND

Asset managers of large manufacturing enterprises, for example, computer manufacturers, electronics manufacturers and auto manufacturers, must determine the inventory levels of components and finished products that are needed to meet target end customer service levels (i.e., the fraction of customer orders that should be received by the requested delivery dates). For such manufacturing enterprises, the delivery of a finished product to an end customer typically involves a complex network of suppliers, fabrication sites, assembly locations, distribution centers and customer locations through which components and products flow. This network may be modeled as a supply chain that includes all significant entities participating in the transformation of raw materials or basic components into the finished products that ultimately are delivered to the end customer.

Each of the steps in a supply chain involves some uncertainty. For example, for a variety of reasons (e.g., changes in product life cycles, seasonal variations in demand, and changing economic conditions), future end customer demand is uncertain. In addition, the times at which ordered raw materials and components will be received from suppliers is uncertain. To handle such uncertainty, many different statistical production planning models have been proposed to optimize production at each level of a supply chain while meeting target service level requirements. In general, there are two different categories of production planning issues: (1) consumable resource (or inventory) planning issues (e.g., planning for finished goods, raw material, or work-in-progress in a manufacturing operation); and (2) reusable resource (or capacity) planning issues (e.g., planning for machine and labor usage in a manufacturing operation).

Master production scheduling (MPS) techniques typically are used by production planners to create manufacturing inventory planning models from which schedules for finished good supplies may be built. A planner may enter forecasted or actual demand requirements (i.e., the quantity of finished goods needed at particular times) into an MPS system. The MPS system then develops a schedule for replenishing the finished goods inventory through the production or procurement of batches of finished goods to meet the demand requirements.

Manufacturing capacity planning, on the other hand, involves a different set of modeling issues, including: (1) selecting tools for producing a particular product mix and volume; (2) selecting a product mix and volume that maximizes the value of an existing tool set; and (3) determining whether additional tools should be added to an existing tool set. Typically, capacity planning issues are addressed by mathematically modeling the manufacturing process. Such models may take the form of a simple spreadsheet, a detailed discrete event simulation, or a mathematical program, such as a linear or mixed integer program. Many capacity planning systems implement various versions of rough cut capacity planning techniques, which typically involve evaluating capacity constraints at some level between the factory and machine levels (e.g., at the production line level). In operation, a planner may enter into a rough cut capacity planning system a build schedule that may have been developed by a MPS system. The rough cut capacity planning system then determines whether sufficient resources exist to implement the build schedule. If not, the planner either must add additional capacity or develop a new build schedule using, for example, MPS techniques.

Typically, MPS and rough cut capacity scheduling procedures are repeated several times before a satisfactory build schedule (i.e., a build schedule that accommodates both inventory requirements and capacity constraints) is achieved. Once a satisfactory build schedule has been developed, the production requirements of the build schedule are supplied to a material requirements planning (MRP) system that develops a final schedule for producing finished goods. To arrive at a final production schedule, a planner may enter into the MRP system a number of production parameters, including production requirements of the build schedule, subassembly and raw materials inventory levels, bills of materials associated with the production of the finished goods and subassemblies, and information regarding production and material ordering lead times. The MRP system then produces a schedule for ordering raw materials and component parts, assembling raw materials and component parts into sub-assemblies, and assembling sub-assemblies into finished goods.

### SUMMARY

The invention features production planning systems and methods that enable production planners to see how capacity decisions affect total production costs and to understand the cost trade offs between excess capacity and inventory and, thereby, enable them to make appropriate manufacturing capacity level and inventory level decisions. A production planner may utilize the inventive production planning systems and methods to plan inventory and capacity levels for one or more products produced on a manufacturing line. In addition to setting capacity and inventory levels, the production planner may use the invention to understand the impact of certain changes (e.g., reducing set-up time or down time, or moving products from one manufacturing line to another) on total production costs.

In one aspect, the invention features a production planning scheme in which inventory and capacity levels are planned for one or more products produced by a manufacturing line based upon one or more production cost amounts. The production cost amounts are computed based upon one or more received capacity attribute values characterizing the manufacturing line and needed to cover expected demand and expected demand uncertainty for the one or more products over an exposure period with a target service level.

Embodiments of the invention may include one or more of the following features.

The received capacity attribute values may be selected from the group consisting of: shift length; number of shifts in a given unit of time; mean time line is inoperable; mean set-up time; set-up time variability; and production scheduling variability.

The inventory and capacity levels may be planned based upon one or more received production attribute values characterizing the one or more products. The production attributes received for each of the one or more products may be selected from the group consisting of: mean demand; demand uncertainty; line cycle time; and average time between builds.

In some embodiments, the inventory and capacity levels may be planned based upon a total production cost amount needed to cover expected demand and expected demand uncertainty for all of the products over an exposure period with a target service level. In other embodiments, the inventory and capacity levels may be planned based upon a respective production cost amount needed to cover expected demand and expected demand uncertainty for each of the products over an exposure period with a target service level.

In one embodiment, one or more capacity attribute values characterizing the manufacturing line are received. One or more production attribute values characterizing the one or more products also are received. Based upon the received capacity attribute values and the received production attribute values, one or more production cost amounts needed to cover expected demand and expected demand uncertainty for the one or more products over an exposure period with a target service level are computed. The one or more computed production cost amounts are displayed. In this embodiment, one or more changes to the capacity attribute and production attribute values may be received. Based upon the received changes, the one or more production cost amounts are recomputed and displayed.

In some embodiments, one or more capacity attribute values characterizing the manufacturing line are input into a production planning system. One or more production attribute values characterizing the one or more products also are input into the production planning system. The production planning system is caused to compute one or more production cost amounts needed to cover expected demand and expected demand uncertainty for the one or more products over an exposure period with a target service level based upon the inputted capacity attribute values and the inputted production attribute values. The production planning system also is caused to display the one or more computed production cost amounts. The one or more computed production cost amounts are analyzed to determine whether the inputted capacity attribute and production attribute values are appropriate.

In these embodiments, one or more changes to the capacity attribute and production attribute values may be input into the production planning system. The production planning system may be caused to re-compute the one or more production cost amounts based upon the received changes, and to display the one or more re-computed production cost amounts. The one or more re-computed production cost amounts may be analyzed to determine whether the inputted capacity attribute and production attribute values are appropriate. The one or more changes input into the production planning system may modify a measure of excess capacity of the manufacturing line. The measure of excess capacity may correspond to one or more measures of manufacturing line utilization (e.g., a set-up time capacity attribute value or a down time capacity attribute value). The one or more changes input into the production planning system may correspond to modification of the number of products produced by the manufacturing line. The one or more changes input into the production planning system may correspond to modification of one or more production attribute values (e.g., a line cycle time production attribute value or a average time between builds production attribute value) for one or more of the products produced by the manufacturing line. The one or more changes input into the production planning system may modify the target service level.

The planning process may be repeated until the inputted capacity attribute and production attribute values are determined to be appropriate.

In another aspect, the invention features a production planning system that includes a production planning engine that is configured to plan inventory and capacity levels for one or more products produced by a manufacturing line based upon one or more production cost amounts. The production cost amounts are computed based upon one or more received capacity attribute values characterizing the manufacturing line and needed to cover expected demand and expected demand uncertainty for the one or more products over an exposure period with a target service level.

In some embodiments, the production planning engine may be configured to receive one or more capacity attribute values characterizing the manufacturing line. The production planning engine also may be configured to receive one or more production attribute values characterizing the one or more products. The production planning engine preferably is configured to compute one or more production cost amounts needed to cover expected demand and expected demand uncertainty for the one or more products over an exposure period with a target service level. The production cost amounts are computed based upon the received capacity attribute values and the received production attribute values.

The production planning engine preferably is configured to receive one or more changes to the capacity attribute and production attribute values. The production planning engine preferably is configured to re-compute the one or more production cost amounts based upon the received changes, and to display the one or more re-computed production cost amounts.

Other features and advantages of the invention will become apparent from the following description, including the drawings and the claims.

### DESCRIPTION OF DRAWINGS

FIG. 1 is a block diagram of a distribution network that includes a factory that is configured to assemble finished goods from component parts that are received from a plurality of suppliers, and a distribution center that stores sufficient levels of finished goods inventory to cover uncertainty in end customer demand with a target service level.

FIG. 2 is a probability density plot of end customer demand for a product.

FIG. 3 is a diagrammatic view of factors that impact the levels of safety stock stored at the distribution center of FIG. 1.

FIG. 4 is a graph of production costs plotted as a function of the manufacturing excess capacity of the factory of FIG. 1 in a graphical representation of a production planning process.

FIG. 5A is a diagrammatic view of a process of deriving measures of manufacturing line responsiveness from sets of production and availability attributes for a manufacturing line of the factory of FIG. 1.

FIG. 5B is a diagrammatic view of a process of deriving inventory levels and production cost values for products produced by a manufacturing line based in part upon the manufacturing line responsiveness measures derived in accordance with the process of FIG. 5A.

FIG. 6A is a front view of a graphical user interface through which a production planner may interface with a production planning system.

FIG. 6B is a front view of a graphical user interface through which a production planner may input a set of manufacturing line production attributes for a product.

FIG. 6C is a front view of a graphical user interface through which a production planner may input a set of availability attributes for a manufacturing line of the factory of FIG. 1.

FIG. 7 is a flow diagram of a basic inventory planning simulation process.

FIG. 8 is a block diagram of an enterprise resource planning system.

FIG. 9 is a flow diagram of a method of planning inventory and capacity levels for one or more products produced by a manufacturing line.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

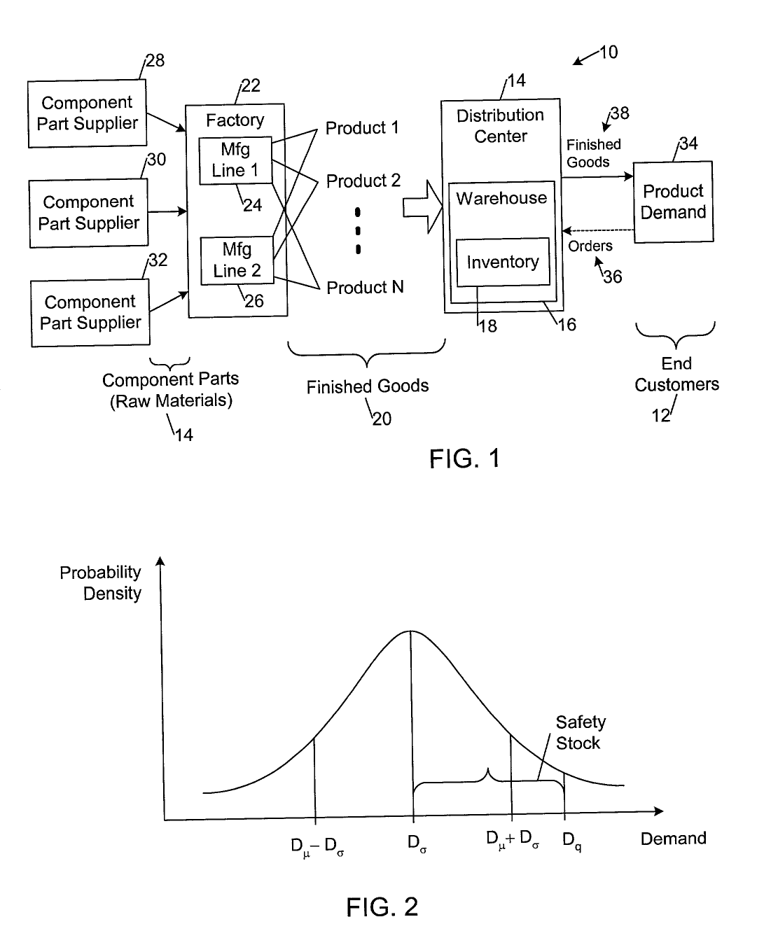

Referring to FIG. 1, in one illustrative embodiment, a simplified distribution system 10 includes a network of end customers 12, and a distribution center 14 with a warehouse 16 that contains a product inventory 18. End customers 12 may include purchasers of branded retail products, purchasers of second label retail products, and direct sales purchasers. Product inventory 18 is replenished by shipments of finished goods 20 from a factory 22. Factory 22 includes a pair of manufacturing lines 24, 26 that are configured to assemble a plurality of products (Product 1, Product 2, Product N) from component parts (or raw materials) that are supplied by a plurality of component part suppliers 28, 30, 32. In operation, end customer demand 34 drives orders 36, which are satisfied by shipments of products 38 from inventory 18. As explained in detail below, a production planner schedules the delivery of finished goods 20 so that the inventory levels at distribution center 14 are sufficient to cover both expected end customer demand and uncertainty in end customer demand. For purposes of discussion, inventory that is used to cover expected end customer demand considering replenishment frequency from the manufacturing line is referred to herein as “cycle stock,” and inventory that is used to cover uncertainty in end customer demand is referred to herein as “safety stock.”

Referring to FIG. 2, future end customer demand 34—which drives the flow of products through distribution system 10—typically is uncertain and may be modeled probabilistically as a probability density function that is plotted as a function of exposure period demand. Various demand forecasting techniques may be used to project future demand 20 by end customers 12 for finished goods 20. For example, future demand may be estimated based on a variety of information, such as experience, customer information, and general economic conditions. Alternatively, demand may be forecasted based upon an analysis of historical shipment data using known statistical techniques. No matter how demand is forecasted, however, the resulting demand forecast typically is characterized by a high level of uncertainty. Typically, future end customer demand 34 is estimated by a probability density function with a normal distribution that is characterized by an estimate of mean demand (D_{μ}) and an estimate of demand uncertainty (e.g., a standard deviation of D_{σ}).

As mentioned above, to protect against uncertainty in actual end customer demand (D_{q}), asset managers must keep a certain minimum inventory level (i.e., safety stock) on hand. In particular, the safety stock level is the amount of product that should be held in stock to cover the variability in demand over the uncertain exposure period in order to meet a target customer service level. The more safety stock that is maintained in warehouse 16, the greater demand variability that may be covered. Of course, if too much safety stock is kept on hand, any unused safety stock will increase product costs and decrease the profitability of the enterprise. As used herein, the service level that is achieved in a particular period is defined as the probability that the product demand in that period plus the unsatisfied product demand in previous periods is met.

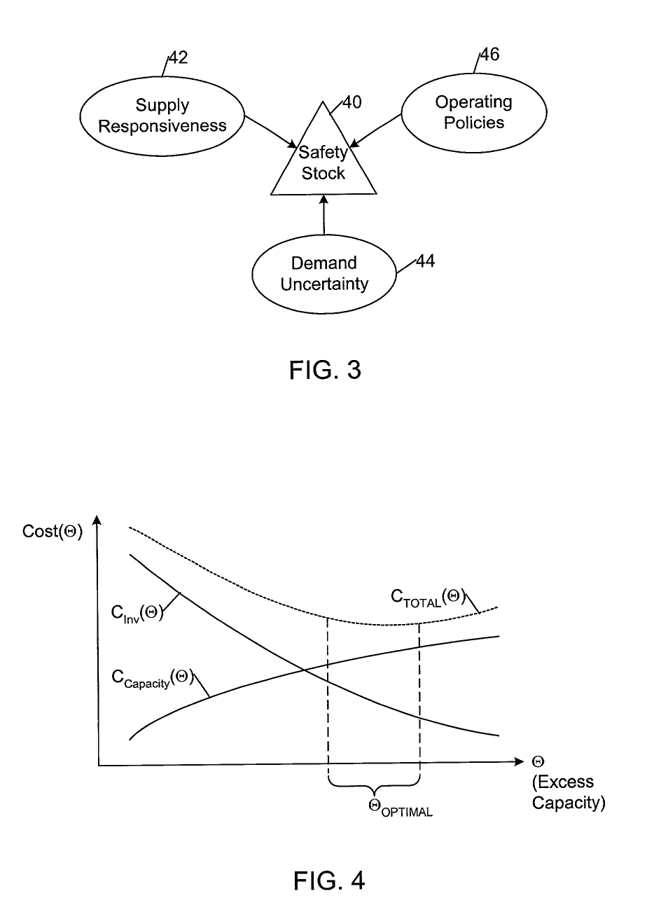

Referring to FIG. 3, from the perspective of the entire supply chain, several factors contribute significantly to the amount of safety stock that should be carried in warehouse 16. In particular, the level of safety stock is influenced significantly by the responsiveness of product supply 42 (e.g., mean replenishment time and replenishment time variability), the level of demand uncertainty 44, and the operating policies 46 selected for the operation of the enterprise (e.g., target service levels). As a general rule of thumb, additional safety stock should be carried when supply responsiveness is low or demand uncertainty is high, or both, and when the desired level of service is high. The inventors have realized, however, that uncertainty in end customer demand need not be buffered entirely with safety stock. Indeed, excess end customer demand also may be buffered on the manufacturing side with excess manufacturing capacity. In particular, the responsiveness of product supply 42 may be increased by raising the level of excess manufacturing capacity to reduce the mean supply replenishment (or lead) time.

As shown diagrammatically in FIG. 4, inventory levels and, consequently, inventory cost (C_{INV}(Θ)) may be reduced as excess capacity (Θ) increases, while still covering uncertainty in excess demand in accordance with a target service level. Although manufacturing capacity cost (C_{CAPACITY}(Θ)) increases as excess capacity is increased, the drop in inventory-driven costs for a given increase in excess capacity may be significantly greater than the resulting increase in capacity costs. Thus, in many cases, a judicious selection of inventory and excess capacity levels may dramatically reduce the overall product production cost (C_{TOTAL}(Θ)=C_{INV}(Θ)+C_{CAPACITY}(Θ)). Indeed, it has been discovered that, in many cases, only a moderate increase in excess manufacturing capacity is needed to reduce total production costs significantly, especially in industries (e.g., the electronic an computer industries) where product life cycles are short and commodity prices erode quickly.

To capitalize on this insight, the inventors have developed a capacity-driven production planning tool (or system) that computes inventory levels and production costs for products produced on a manufacturing line based upon sets of manufacturing capacity data, demand data, and operating policy data. With this tool, production planners may see how capacity decisions affect total production costs and understand the cost trade offs between excess capacity and inventory and, thereby, make appropriate manufacturing capacity and inventory level decisions.

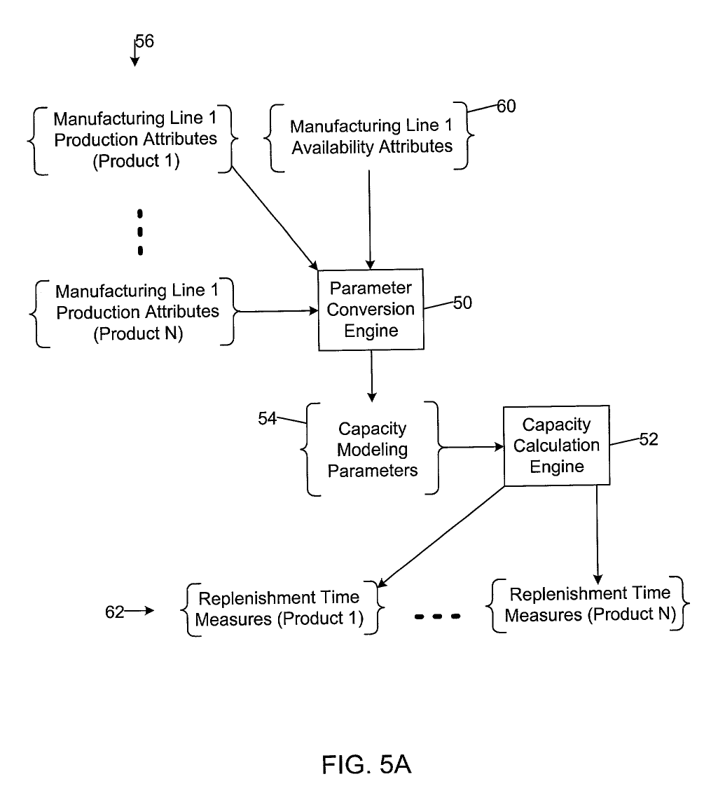

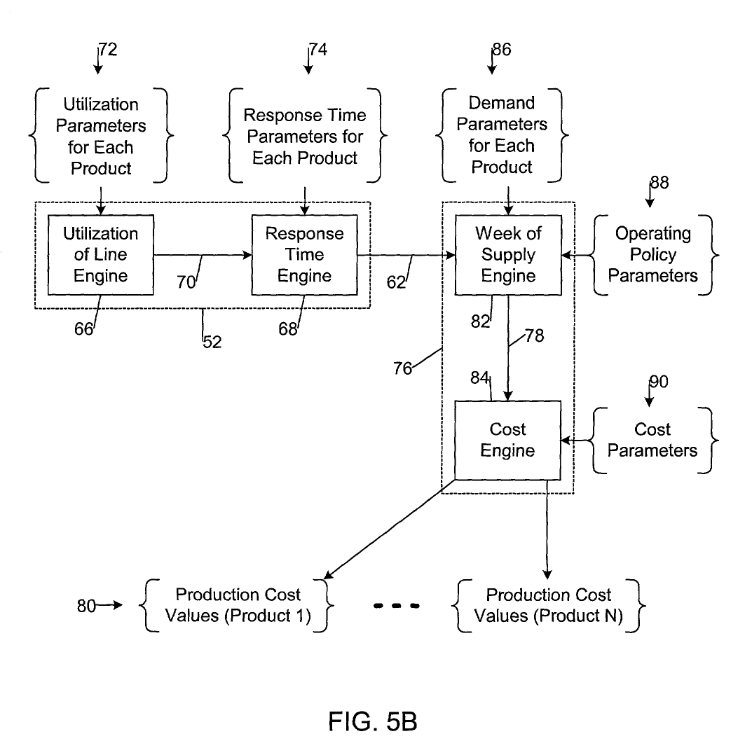

Referring to FIGS. 5A and 5B, in one embodiment, the production planning tool includes a parameter conversion engine 50 and a capacity calculation engine 52. Parameter conversion engine 50 is configured to derive a set 54 of capacity modeling parameters from sets 56 of production attributes for the products being manufactured on a manufacturing line and a set 60 of availability attributes for the same manufacturing line. Capacity calculation engine 52 is configured to compute measures 62 of the responsiveness of the manufacturing line from the set of capacity modeling parameters 54. In one embodiment, the capacity calculation engine 52 is configured to compute measures of the replenishment time and replenishment time variability for each product produced by the manufacturing line. As shown in FIG. 5B, capacity calculation engine 52 includes a utilization of line engine 66 and a response time engine 68. Utilization of line engine is configured to derive measures 70 of line utilization from a set 72 of utilization modeling parameters that are computed by parameter conversion engine 50. Response time engine 68 is configured to compute the measures 62 of manufacturing line responsiveness from the measures 70 of line utilization and from a set 74 of response time modeling parameters that are computed by parameter conversion engine 50 for each product that is produced on the manufacturing line.

The measures 62 of manufacturing line responsiveness are used by an inventory calculation engine 76 to compute inventory levels 78 and production costs 80 for products produced on the manufacturing line. Inventory calculation engine 76 includes a weeks of supply engine 82 and a cost engine 84. Weeks of supply engine 82 is configured to receive the manufacturing line responsiveness measures 62 and a set 86 of product demand modeling parameters and, based on this information, compute product inventory levels 78 that are sufficient to cover uncertainty in end customer demand with a service level specified by one or more operating policy parameters 88. Cost engine 84 is configured to compute the production cost values 80 based upon the computed product inventory levels 78 and a set 90 of cost parameters for the products produced on the manufacturing line.

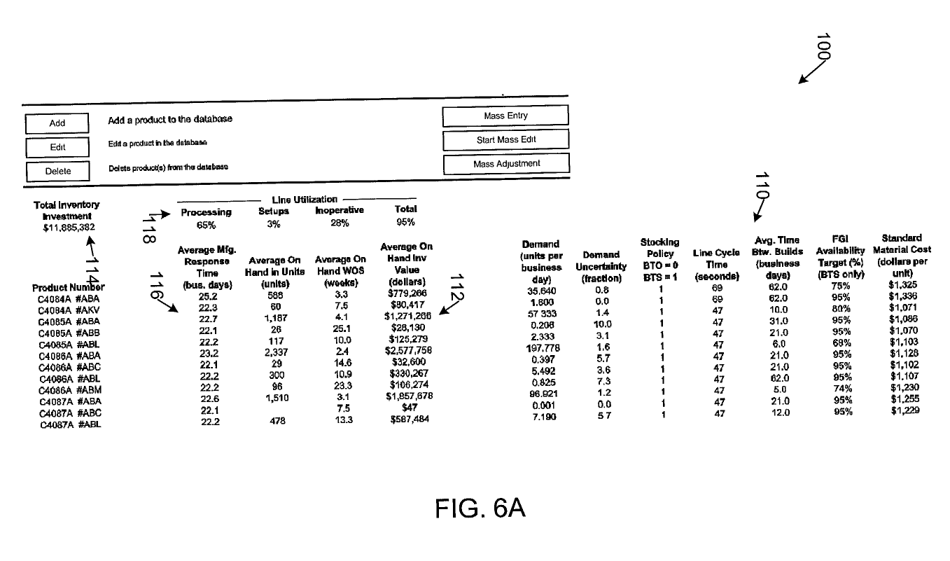

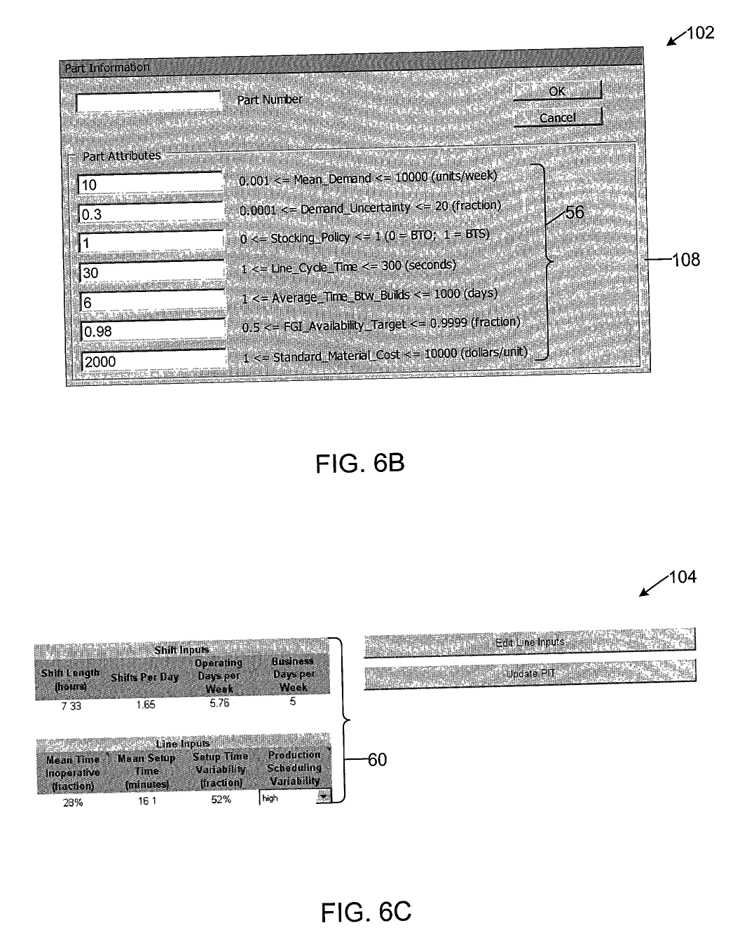

Referring to FIGS. 6A, 6B and 6C, the production attribute data 56 and the manufacturing line availability data 60 may be entered into the production planning system by a production planner through a set of graphical user interfaces 100, 102, 104. Graphical user interfaces 100-104 separate the presentation of information to a production planner from the underlying representation of calculations and interrelationships that are used by the production planning system to compute inventory levels and production costs for products produced on a manufacturing line. The graphical user interfaces 100-104 therefore free production planners from having to handle underlying references directly and, thereby, allow them to focus instead on the contexts and concepts of production planning.

The operation of the production planning system may be best understood with reference to the production parameter terms listed in the index of Appendix A and defined in the glossary of Appendix B. In general, the production parameters may be classified into the following categories: (1) product production input attributes 56; (2) manufacturing line availability input attributes 60; (3) product-specific production planning modeling parameters; (4) line-specific production planning modeling parameters; (5) inventory modeling parameters; (6) inventory output parameters; and (7) capacity output parameters. The product production input attributes 56 and the manufacturing line availability input attributes 60 are entered into the system by a production planner through graphical user interfaces 100-104. Based upon this information, the production planning system computes values for the remaining parameters and presents values for the inventory and capacity output parameters to the production planner through graphical user interface 100.

As shown in FIGS. 6A and 6B, in one embodiment, graphical user interface 100 enables a production planner to interact with the production planning system. Graphical user interface 100 includes seven icons that may be activated to invoke a respective function for supplying production attribute information to the production planning system. In general, graphical user interface 100 includes icons (“Add” and “Mass Entry”) for adding one or more products, icons (“Edit”, “Edit Line Inputs”, and “Mass Edit”) for editing attributes of one or more previously added products, and icons (“Delete” and “Mass Adjustment”) for deleting one or more previously added products. The functions that are invoked by activating these icons are described in detail below.

Operating Modes Invokable through the Graphical User Interface Adding Product Information

The Add Function

By activating the “Add” icon that is presented by graphical user interface 100, a production planner may enter values for a prescribed set of production attributes for a product being produced on a given manufacturing line. In particular, upon activation of the Add icon, a product attribute dialog box 108 (FIG. 6B) opens prompting the production planner to enter values for a set of product production attributes 56. Among the product production attribute values that may be entered into the system for each product are: (1) product number; (2) mean demand; (3) demand uncertainty; (4) stocking policy (e.g., build to stock (BTS) or build to order (BTO)); (5) line cycle time; (6) average time between builds; (7) finished goods inventory (FGI) availability target; and (8) standard material cost. Each of these terms is defined in Appendix B. After values have been entered for each of these terms, they are displayed by graphical user interface 100 as a product attribute input data table 110 (FIG. 6A).

The Mass Entry Function

This operation allows the user to quickly add a set of parts to the production planning tool database, using default settings for all of the input parameters. A production planner may perform this operation by first pasting a set of part numbers into an adjacent Excel spreadsheet (or workbook). With the Excel spreadsheet (the source) containing the set of part numbers to be added to the database open, the production planner may return to the Control sheet and select the Mass Entry button. A Multiple Part dialog box will appear. The production planner may then activate the source spreadsheet and select (or type the full address, including the sheet name) of the range containing the part numbers. A Mass Entry Completion dialog box will appear prompting the production planner to select an OK button. Changes may be saved by choosing the Save command from the Excel® File Menu.

### Editing Product Information

The Edit Function

In many respects, this operation is similar to the Add operation. It uses the same dialog box, and requires the same information from the production planner. The difference is that it works off data for an item that is already in the database. The first step of the operation is for the production planner to identify a particular part or product by selecting the pertinent cell on the Control sheet. (If more than one cell is selected, the production planner will be prompted to limit the selection to a single part). The part may be selected by typing in the part's label, or selecting the cell on the Control sheet containing the label of the part/product to be edited. The production planner may then select the Edit button, which invokes a Part Information dialog box. The values for any inputs that have changed may be modified. (Information from a drop-down box may be selected by using either the mouse or the up and down arrows on the keyboard.) The spreadsheet may be updated by select the OK button when all inputs have been entered. Changes may be saved by choosing the Save command from the Excel® File Menu.

Edit Line Inputs Function

Until the Edit Line Inputs button is activated, the data on the user interface for manufacturing line inputs is locked and cannot be altered. By activating the Edit Line Inputs button, the production planner unlocks only those cells that contain input data or a drop-down list while protecting the remaining cells containing headers and/or formulas from accidental alterations. The actions of selecting the Edit Line Inputs button and changing the data in the input cells, however, do not cause production planning system to rerun inventory calculations and update outputs on graphical user interface 100. To update the production planning system, the production planner must select the Update button. As a reminder to the production planner to take this final action, the font on the Update button is changed to a red font and bolded as soon as the Edit Line Inputs button has been activated. After selecting the Update button, the script on the button is restored to its regular font, all the cells on the page are locked, the production planning system reruns all of the inventory calculations, and the production planner is returned to graphical user interface 100 to view the updated outputs and recommendations.

The Mass Edit Function

When the Mass Edit capability of the production planning tool is activated, the graphical user interface is essentially turned off to allow the production planner to interact directly with the spreadsheet containing the part database. The button to invoke this operation is labeled “Start Mass Edit”. While the tool is in Mass Edit mode, the button is relabeled “Finish Mass Edit”, the other buttons and Excel's command menu and toolbars are disabled, and the background color of the spreadsheet is changed to identify the tool's state. Once the production planner completes the desired edits, the production planner must activate the “Finish Mass Edit” button to complete the operation and return the tool to its normal state.

The Mass Edit function enables the production planner to make bulk changes to part input attributes. To make bulk edits to the database, the production planner initially must select the Start Mass Edit button. A warning box appears reminding the production planner not to make any changes to the part numbers or category ranges. The production planner then must select the OK button to proceed. The Control sheet's background color changes as a visual reminder that the production planning tool is in the Mass Edit mode. The production planner then may make desired modifications to the non-categorized part attributes in the control spreadsheet. The production planner may select the Finish Mass Edit button to exit Mass-Edit mode and return the tool to its normal state. The background color reverts to normal. Changes may be saved by choosing the Save command from the Excel® File Menu.

### Deleting Product Information

The Delete Function

The Delete operation allows the production planner to remove parts or products from the database. In this mode of operation, the graphical user interface prompts the user to identify the item(s) to be deleted. As with the Edit operation, the production planner may either type in the part number(s) or select the cell(s) on the control sheet that contains the desired part/product number. Because adding the parts again is a straightforward operation, there is no confirmation step. Changes may be saved by choosing the Save command from the Excels File Menu.

The Mass Adjustment Function

The operation of the Mass Adjustment function is similar to the operation of the Mass Edit function. It allows the production planner to make bulk changes to input parameters. The difference is that the operation is more controlled and the production planner has much less freedom using the Mass Adjustment feature. Instead of being allowed direct access to the part database, the production planner is given a part-independent dialog box within which to identify new values for input attributes. Any changes that the production planner makes are then applied to all of the parts in the database.

The mechanism for modifying each input attribute depends whether it is categorized or not. The production planner may enter a new value directly into a Mass Adjustment dialog edit-box. The production planner may enter the absolute value of the input variable that is to be set to for all parts. When the production planner closes the dialog box (using the “OK” button), the production planning tool makes the modifications on the entire database, updates the calculations, and reloads the data into the database on the Control sheet. Changes may be saved by choosing the Save command from the Excel® File Menu.

As shown in FIG. 6C, after production attributes 56 have been entered for each of the products produced by the manufacturing line, a production planner may enter through graphical user interface 104 values for a set of availability (or capacity) attributes 60 for the given manufacturing line. Among the availability attribute values that may be entered into the system for a given manufacturing line are: (1) shift length; (2) number of shifts per day; (3) number of production days per week; (4) number of business days per week; (5) mean time the line is inoperative; (5) mean set-up time; (6) set-up time variability; and (7) production scheduling variability. The mean time the line is inoperative is the fraction of available capacity that is consumed by non-productive activities, including maintenance, repairs, shortages, missing paperwork, and the like. The production scheduling variability depends at least in part upon the following factors: variability in scheduling practices; rescheduling due to parts shortages; expediting practices; set-up sequencing practices; and frequency of build to order production. Each of these terms is defined in Appendix B.

Referring back to FIG. 6A, in response to a request to update the system with new values that have been entered by a production planner, the production planning system presents sets of output data reflecting: (1) product-specific inventory investment information 112; (2) total inventory investment information 114; (3) product-specific manufacturing line capacity information 116; and (4) total line capacity information 118. The product-specific inventory investment information 112 includes the average number of units that are on hand for each product, the average number of weeks of supply (WOS) for each product, and the average value of on hand inventory for each product. The total inventory investment information 114 corresponds to the sum of the average values of on hand inventory for all products. The product-specific manufacturing line capacity information 116 corresponds to the average manufacturing response time for each product. The total line capacity information 118 reflects the total line utilization and the line utilization breakdown between processing time, set-up time, and down time.

Based upon the information presented by graphical user interface 100, production planners may see how capacity decisions affect total production costs and understand the cost trade offs between excess capacity and inventory and, thereby, make appropriate manufacturing capacity and inventory level decisions. Thus, a production planner may change one or more production attribute values to see how such changes might impact overall production costs, including manufacturing and inventory-driven costs. In particular, a production planner may try to reduce overall production costs by increasing the level of excess capacity while reducing inventory levels. For example, a production planner may increase excess capacity by reducing one or more product production attributes, such as set-up time and set-up time variability, or adjusting one or more manufacturing line availability attributes (e.g., reduce down time or increase the number of shifts). In response to these new values, the production planning system will compute the inventory levels needed to cover uncertainties in end customer demand with the target service level. As mentioned above, in many cases, only a moderate increase in excess manufacturing capacity may be needed to reduce total production costs significantly, especially in industries (e.g., the electronic an computer industries) where product life cycles are short and commodity prices erode quickly. A production planner may run still other production scenarios through the production planning system in an effort to determine optimal capacity and inventory schedules under existing production conditions.

Other embodiments are within the scope of the claims.

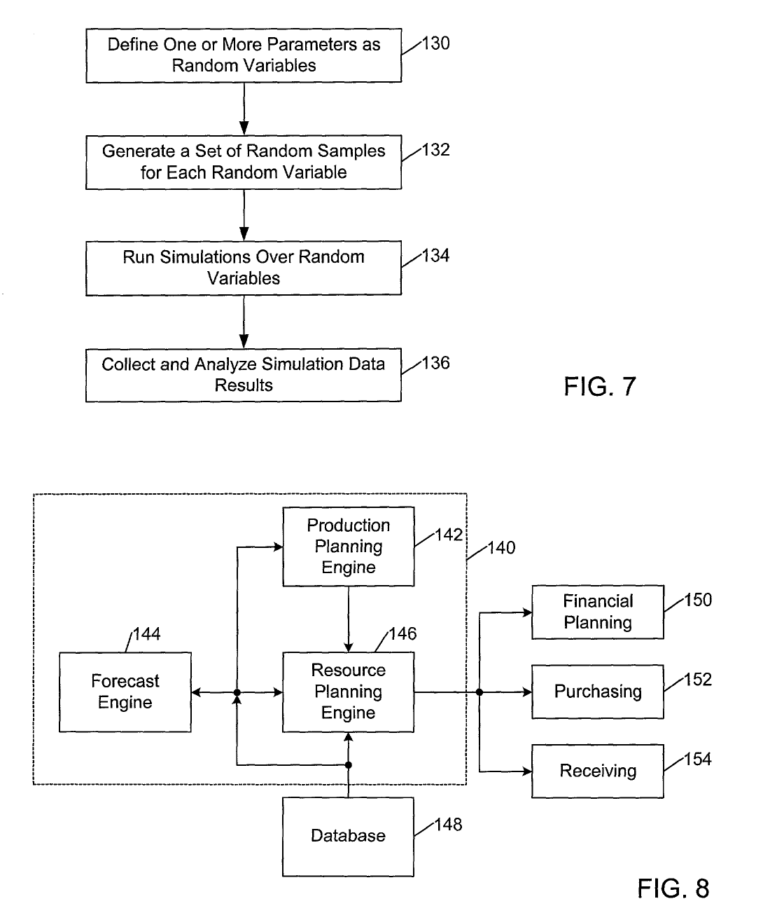

Referring to FIG. 7, the above-described inventory planning process may be extended by treating one or more input parameters (e.g., product production attributes, manufacturing line availability attributes, and operating policy parameters) stochastically. In accordance with another inventory planning embodiment, one or more input parameters are defined as random variables (step 130). A set of random samples for each random variable is generated (step 132). The sets of random samples may be generated based upon a selected probability distribution that matches an estimate of the mean and standard deviation for the random variable. Random samples are generated from the selected probability distribution using any one or several conventional techniques (e.g., the inverse transform method). Simulations (e.g., Monte Carlo simulations) are then run over the random variables (step 134). For information relating to Monte Carlo simulation techniques see, for example, PAUL BRATLEY ET AL., A GUIDE TO SIMULATION (1987) and JERRY BANKS ET AL., DISCRETE-EVENT SYSTEM SIMULATION (1996). The resulting data produced from the simulations is collected and analyzed statistically (step 136). This data may be presented to the production planner as a graph of total production cost plotted as a function of manufacturing line capacity, as in FIG. 4. This inventory planning process embodiment enables production planners to make statistically significant decisions relating to one or more of the input parameters and, therefore, make better production planning decisions.

As shown in FIG. 8, in another embodiment, the above-described inventory planning processes may be incorporated into an enterprise resource planning system 140 that is configured to estimate future on-hand inventory requirements and future replenishment requirements. Enterprise resource planning system 140 includes an production planning engine 142, a forecast engine 144, an enterprise resource planning engine 146, and a database 148. Production planning engine 142 is configured to implement the production planning processes described above based at least in part upon parameters supplied by a user or by forecast engine 144, or both. Forecast engine 144 is configured to analyze historical shipment data contained in database 148 and to compute an estimate of mean future demand 34 by end customers 12 for products 20, as well as compute an estimate of future demand variability. Enterprise resource planning engine 146 is configured to receive production planning information from production planning engine 142 and forecast information from forecast engine 144, and from this information estimate inventory levels at various distribution points in the supply chain using standard enterprise resource planning techniques. In particular, enterprise resource planning engine 146 may be operable to recursively compute replenishment requirements for a specific product at each distribution point. The distribution points may include warehouses, terminals or consignment stock at a distributor or a customer. Enterprise resource planning engine 146 may be configured to compute and set re-stock trigger points so that product may be shipped in time from the manufacturing facility to the distribution points. In one embodiment, enterprise resource planning engine 146 estimates distribution point inventory levels based upon information relating to the lead time needed to manufacture and transport product from the manufacturing facility to the distribution point. Information generated by enterprise resource planning system 140 may be transmitted to a financial planning unit 150, a purchasing unit 152 and a receiving unit 154 to carry out the resource planning recommendations of the system.

### Capacity-Driven Production Planning

A production planner may utilize the above-described production planning systems and methods to plan inventory and capacity levels for one or more products produced on a manufacturing line. These production planning systems and methods enable the production planner to see how capacity decisions affect total production costs and to understand the cost trade offs between excess capacity and inventory. In this way, production planners may make appropriate decisions in setting manufacturing capacity and inventory levels. In addition to setting capacity and inventory levels, the production planner may use these production planning systems and methods to understand the impact of certain changes (e.g., reducing set-up time or down time, or moving products from one manufacturing line to another) on total production costs.

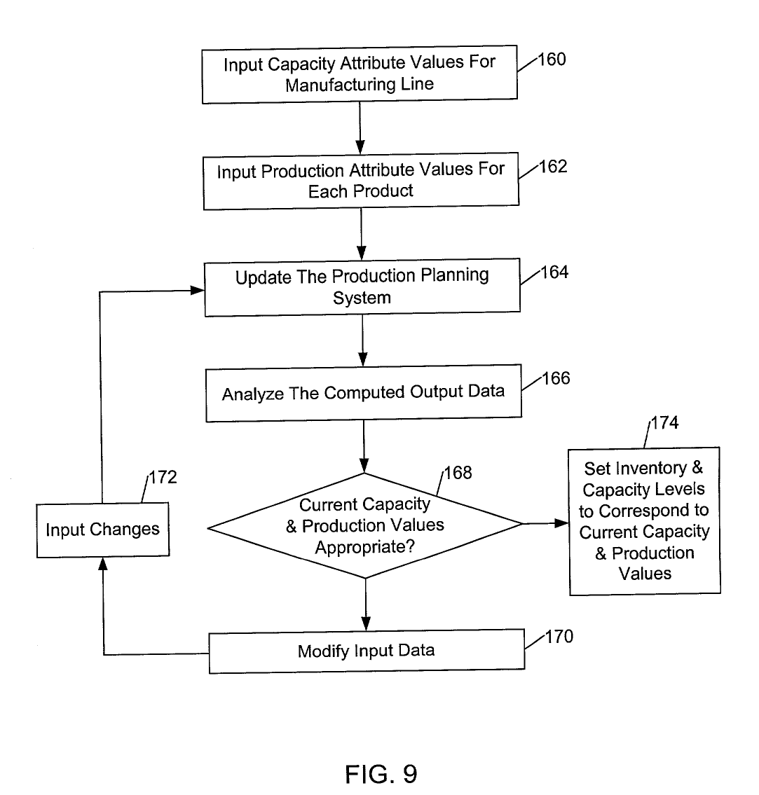

Referring to FIG. 9, in one embodiment, a production planner may plan inventory and capacity levels as follows. Initially, the production planner enters into the production planning system a set of capacity attribute values characterizing a manufacturing line (step 160). Among the capacity attribute values that may be entered into the system for a given manufacturing line are: (1) shift length; (2) number of shifts per day; (3) number of production days per week; (4) number of business days per week; (5) mean time the line is inoperative; (5) mean set-up time; (6) set-up time variability; and (7) production scheduling variability. Each of these terms is defined in Appendix B. The production planner also enters into the production planning system a set of production attribute values for each of the products produced on the manufacturing line (step 162). Among the product production attribute values that may be entered into the system for each product are: (1) product number; (2) mean demand; (3) demand uncertainty; (4) stocking policy (e.g., build to stock (BTS) or build to order (BTO)); (5) line cycle time; (6) average time between builds; (7) finished goods inventory (FGI) availability target; and (8) standard material cost. Each of these terms also is defined in Appendix B. The production planner then updates the production planning system (step 164). In response, the production planning system computes sets of output data reflecting: (1) product-specific inventory investment information 112; (2) total inventory investment information 114; (3) product-specific manufacturing line capacity information 116; and (4) total line capacity information 118.

The production planner may analyze the computed output data to determine whether the current sets of capacity and production attribute values are appropriate (step 166). In general, the production planner should select sets of capacity and production attribute values that minimize the total production cost needed to cover expected demand and expected demand uncertainty for the one or more products over an exposure period with a target service level. If the current sets of capacity and production attribute values are not appropriate (step 168), the production may modify one or more data values (step 170), input the changes into the production planning system (step 172), and update the production planning system (step 164). The production planner may repeat these steps (steps 164-172) until the current sets of capacity and production attributes are determined to be appropriate (step 168), at which point, the production planner may set the actual inventory and capacity levels to correspond to the current sets of capacity and production attribute values (step 174).

During the production planning process, the production planner may change one or more capacity attribute values affecting the excess capacity level of the manufacturing line. For example, the production planner may change one or more measures of manufacturing line utilization, such as the set-up time or the down time. As mentioned above, in certain circumstances, by increasing excess capacity (e.g., by decreasing set-up time or down time, or both, or adding one of more shifts to the line) while reducing inventory levels the total production cost may be reduced. In these circumstances, the excess capacity is used to buffer against demand uncertainty and, thereby, allows inventory levels to be reduced. The production planner also may change the excess capacity of the manufacturing line by modifying the number of products being produced on the line. For example, in some circumstances, by removing a product from one line to another, the excess capacities of both manufacturing lines may be optimized to reduce overall production costs.

During the production planning process, the production planner also may change one or more production attribute values affecting the replensihment time for one or more of the products produced by the manufacturing line. For example, the production planner may change one or more of the line cycle time or the average time between builds for one or more products to determine how changes to these production parameters impact inventory levels for these products and total production costs.

The production planner may change other input parameters, such as the target service level, to determine how changes to these parameters impact total production costs.

Although systems and methods have been described herein in connection with a particular computing environment, these systems and methods are not limited to any particular hardware or software configuration, but rather they may be implemented in any computing or processing environment, including in digital is electronic circuitry or in computer hardware, firmware or software. In general, the component engines of the production planning system may be implemented, in part, in a computer process product tangibly embodied in a machine-readable storage device for execution by a computer processor. In some embodiments, these systems preferably are implemented in a high level procedural or object oriented processing language; however, the algorithms may be implemented in assembly or machine language, if desired. In any case, the processing language may be a compiled or interpreted language. The methods described herein may be performed by a computer processor executing instructions organized, for example, into process modules to carry out these methods by operating on input data and generating output. Suitable processors include, for example, both general and special purpose microprocessors. Generally, a processor receives instructions and data from a readonly memory and/or a random access memory. Storage devices suitable for tangibly embodying computer process instructions include all forms of non-volatile memory, including, for example, semiconductor memory devices, such as EPROM, EEPROM, and flash memory devices; magnetic disks such as internal hard disks and removable disks; magneto-optical disks; and CD-ROM. Any of the foregoing technologies may be supplemented by or incorporated in specially designed ASICs (application-specific integrated circuits).

Still other embodiments are within the scope of the claims.

[image]

[image]

[image]

[image]

[image]

[image]

[image]

[image]

[image]

[image]

[image]

[image]

[image]

[image]

[image]

What is claimed is:

1. A production planning method, comprising:
planning inventory and capacity levels for one or more products produced by a manufacturing line based upon one or more production cost amounts computed based upon one or more received capacity attribute values characterizing the manufacturing line and needed to cover expected demand and expected demand uncertainty for the one or more products over an exposure period with a target service level.

2. The method of claim 1, wherein the received capacity attribute values are selected from the group consisting of: shift length; number of shifts in a given unit of time; mean time line is inoperable; mean set-up time; set-up time variability; and production scheduling variability.

3. The method of claim 1, wherein the inventory and capacity levels are planned based upon one or more received production attribute values characterizing the one or more products.

4. The method of claim 3, wherein the production attributes received for each of the one or more products are selected from the group consisting of: mean demand; demand uncertainty; line cycle time; and average time between builds.

5. The method of claim 1, wherein the inventory and capacity levels are planned based upon a total production cost amount needed to cover expected demand and expected demand uncertainty for all of the products over an exposure period with a target service level.

6. The method of claim 1, wherein the inventory and capacity levels are planned based upon a respective production cost amount needed to cover expected demand and expected demand uncertainty for each of the products over an exposure period with a target service level.

7. The method of claim 1, wherein planning the inventory and capacity levels comprises:
receiving one or more capacity attribute values characterizing the manufacturing line;
receiving one or more production attribute values characterizing the one or more products;
based upon the received capacity attribute values and the received production attribute values, computing one or more production cost amounts needed to cover expected demand and expected demand uncertainty for the one or more products over an exposure period with a target service level; and
displaying the one or more computed production cost amounts.

8. The method of claim 7, further comprising:
receiving one or more changes to the capacity attribute and production attribute values;
based upon the received changes, re-computing the one or more production cost amounts; and
displaying the one or more re-computed production cost amounts.

9. The method of claim 1, wherein planning the inventory and capacity levels comprises:
inputting into a production planning system one or more capacity attribute values characterizing the manufacturing line;
inputting into the production planning system one or more production attribute values characterizing the one or more products;
causing the production planning system to compute one or more production cost amounts needed to cover expected demand and expected demand uncertainty for the one or more products over an exposure period with a target service level based upon the inputted capacity attribute values and the inputted production attribute values, and to display the one or more computed production cost amounts; and
analyzing the one or more computed production cost amounts to determine whether the inputted capacity attribute and production attribute values are appropriate.

10. The method of claim 9, further comprising:
(a) inputting into the production planning system one or more changes to the capacity attribute and production attribute values;
(b) causing the production planning system to re-compute the one or more production cost amounts based upon the received changes, and to display the one or more re-computed production cost amounts; and
(c) analyzing the one or more re-computed production cost amounts to determine whether the inputted capacity attribute and production attribute values are appropriate.

11. The method of claim 10, wherein the one or more changes input into the production planning system modify a measure of excess capacity of the manufacturing line.

12. The method of claim 11, wherein the measure of excess capacity corresponds to one or more measures of manufacturing line utilization.

13. The method of claim 12, wherein the one or more changes correspond to modification of one or more of a set-up time capacity attribute value or a down time capacity attribute value.

14. The method of claim 10, wherein the one or more changes input into the production planning system correspond to modification of the number of products produced by the manufacturing line.

15. The method of claim 10, wherein the one or more changes input into the production planning system correspond to modification of one or more production attribute values for one or more of the products produced by the manufacturing line.

16. The method of claim 15, wherein the one or more changes correspond to modification of one or more of a line cycle time production attribute value or a average time between builds production attribute value.

17. The method of claim 10, wherein the one or more changes input into the production planning system modify the target service level.

18. The method of claim 10, further comprising repeating steps (a)-(c) until the inputted capacity attribute and production attribute values are determined to be appropriate.

19. A production planning system, comprising a production planning engine configured to
plan inventory and capacity levels for one or more products produced by a manufacturing line based upon one or more production cost amounts computed based upon one or more received capacity attribute values characterizing the manufacturing line and needed to cover expected demand and expected demand uncertainty for the one or more products over an exposure period with a target service level.

20. The system of claim 19, wherein the production planning engine is configured to:
receive one or more capacity attribute values characterizing the manufacturing line;
receive one or more production attribute values characterizing the one or more products; and
compute, based upon the received capacity attribute values and the received production attribute values, one or more production cost amounts needed to cover expected demand and expected demand uncertainty for the one or more products over an exposure period with a target service level.

21. The system of claim 20, wherein the production planning engine is configured to:
receive one or more changes to the capacity attribute and production attribute values; and
re-compute the one or more production cost amounts based upon the received changes.
